(19) United States
(12) Patent Application Publication
(10) Pub. No.: US 2012/0056896 A1
(43) Pub. Date: Mar. 8, 2012

(54) PRESENTING INFORMATION ON A SEE-THOUGH DISPLAY

(76) Inventor: John N. Border, Walworth, NY (US)

(21) Appl. No.: 12/874,288

(22) Filed: Sep. 2, 2010

(51) Int. Cl. G09G 5/02

(52) U.S. Cl. 345/592

(57) ABSTRACT

A method for displaying information on a see-through display to provide improved viewability of digital information to a user, includes: providing a see-through display including control electronics, an image source with optics and a transparent viewing area, so that a user can view a scene with overlying digital information on the transparent viewing area of the see-through display and receiving digital information and providing the digital information to the control electronics. The method further includes using the control electronics to modify the digital information to increase viewability and providing the modified digital information to the image source so that the modified digital information is presented on the transparent viewing area overlying the viewed scene.

### CROSS REFERENCE TO RELATED APPLICATIONS

Reference is made to commonly assigned U.S. patent application Ser. No. 12/862,978 filed Aug. 25, 2010, entitled “Head-Mounted Display Control by John N. Border et al; U.S. patent application Ser. No. 12/862,985 filed Aug. 25, 2010, entitled “Head-Mounted Display With Biological State Detection” by John N. Border et al; U.S. patent application Ser. No. 12/862,998 filed Aug. 25, 2010, entitled “Head-Mounted Display With Eye State Detection” by John N. Border et al, U.S. patent application Ser. No. 12/868,013 filed Aug. 25, 2010, entitled “Head-Mounted Display With Environmental State Detection” by John N. Border et al, and U.S. patent application Ser. No. 12/862,994 filed Aug. 25, 2010, entitled “Switchable Head-Mounted Display” by John N. Border et al, the disclosures of which are incorporated herein.

### FIELD OF THE INVENTION

The present invention relates to a see-through display. More particularly, the present invention relates to a method for presenting information on a see-through display.

### BACKGROUND OF THE INVENTION

See-through displays are widely used in the presentation of information to viewers where the viewer needs to be able to see a background image as well. See-through displays are also known as augmented reality displays. See-through displays include substantially transparent panels through which the user views a scene, together with suitable optics to present overlaid electronic imagery to a user's eyes. See-through displays provide an augmented reality view in which real-world scenes are visible to a user as a see-through view and additional images or information is overlaid on the see-through view to present a combination image to the user. Such an augmented reality view is provided by head mounted displays for gaming, helmet mounted displays found in military applications, by heads-up displays (HUDs) in the windshields of automobiles and by the heads-up displays in the windscreens or canopies of aircraft.

FIG. 1 shows a typical prior-art head-mounted display that is a see-through display 10. The head-mounted display 10 includes: ear pieces 14 to locate the device on the user's head; see-through viewing areas 12; microprojectors 8 and control electronics 9 to provide images to the microprojectors 8.

U.S. Pat. No. 6,829,095 describes a device with a see-through display 10 or augmented reality display in a head-mounted glasses format where digital information is presented within see-through viewing areas 12. The see-through viewing areas 12 include waveguides to carry an image of the digital information from microprojectors 8 to portions of the see-through viewing areas 12 where the user can view the digital information. A built-in array of partially reflective surfaces inside the waveguides reflects the image of the digital information out of the waveguide in the portions of the see-through viewing areas 12 and in the direction of the user's eyes. The user then views a combination image that includes the see-through view of the external scene and the digital information from the microprojector. A reflectance of 20% to 33% is suggested in U.S. Pat. No. 6,829,095 for the partial reflectors to provide a suitable brightness of the digital information when combined with the see-through view of the scene as seen in the see-through display. However, the digital information provided by the device in U.S. Pat. No. 6,829,095, can be difficult to view, since the background image provided by the see-through view varies by region in brightness and color in correspondence with the scene content. In addition, since the digital information is overlaid onto the see-through view, the digital information cannot be made to be darker in the combination image than the see-through view. When viewing a scene where a portion of the see-through view is bright and the same color as the digital information, the digital information is indistinguishable. While it is well known that digital information such as text should be a contrasting color compared to the background to make the text easier to read, in a see-through display the color or brightness of the regions of the see-through view are often not known. This problem is common amongst different types of see-through displays.

U.S. Pat. No. 7,710,655 describes an apparatus and method for a see-through display wherein a variable occlusion member is attached to a portion of the see-through display as a layer over the portion of the see-through viewing area that digital information is presented by the display. The variable occlusion member is a device which can be controlled to block a percentage of the transmitted light that passes through the portion of the see-through viewing area from the external environment so that the see-through view becomes less visible in the portion and the viewability of the digital information is correspondingly improved in the portion. The variable occlusion layer is adjusted from dark to light in response to the brightness of the ambient environment to provide improved viewing conditions. Although the viewability of the digital information is improved by the apparatus and method of U.S. Pat. No. 7,710,655, variable occlusion members can be expensive and complicated to operate.

There is a need, therefore, for an improved see-through display that provides a low cost and simple approach for providing improved viewability of digital information that is overlaid on a see-through view of a scene.

### SUMMARY OF THE INVENTION

In accordance with the present invention, there is provided a method for displaying information on a see-through display to provide improved viewability of digital information to a user, comprising:

(a) providing a see-through display including: control electronics, an image source with optics and a transparent viewing area, so that a user can view a scene with overlying digital information on the transparent viewing area of the see-through display;

(b) receiving digital information and providing the digital information to the control electronics;

(c) using the control electronics to modify the digital information to increase viewability; and

(d) providing the modified digital information to the image source so that the modified digital information is presented on the transparent viewing area overlying the viewed scene.

The present invention improves viewability of digital information displayed on a see-through display.

### BRIEF DESCRIPTION OF THE DRAWINGS

The above and other objects, features, and advantages of the present invention will become more apparent when taken in conjunction with the following description and drawings, wherein identical reference numerals have been used, where possible, to designate identical features that are common to the figures, and wherein:

FIG. 1 is an illustration of a prior art head-mounted display;

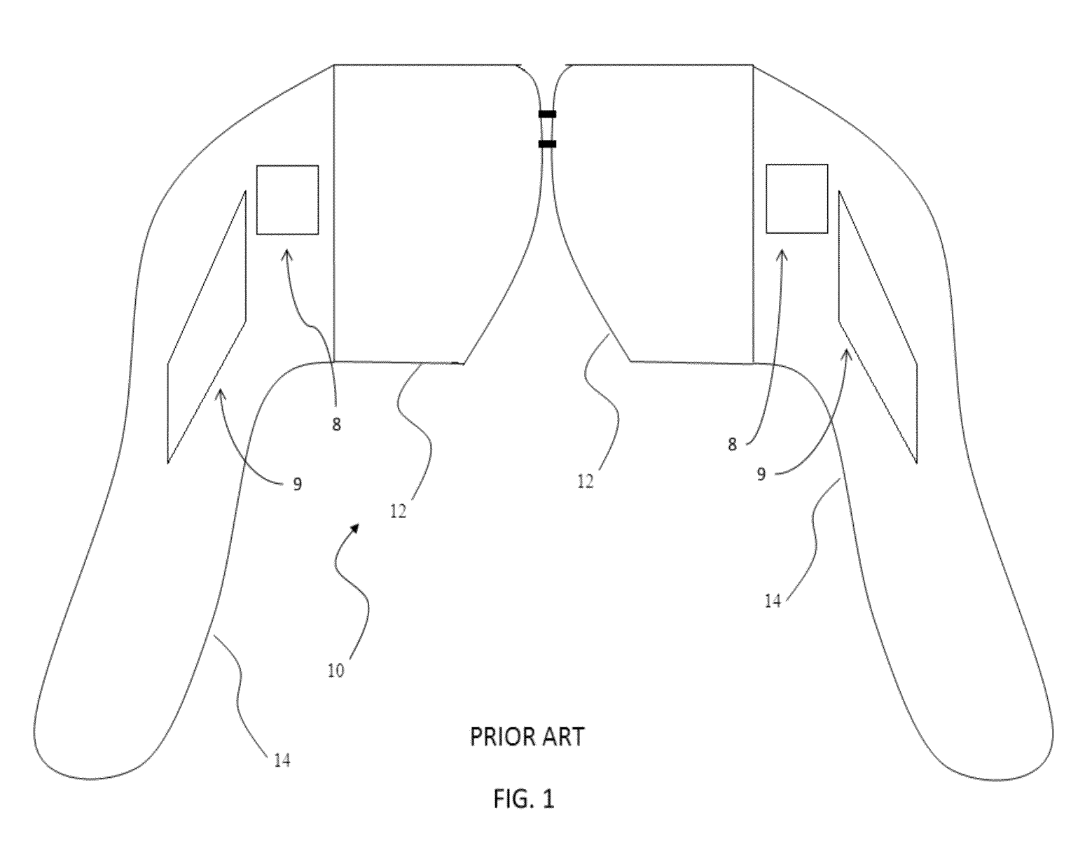

FIG. 2 is an illustration of a combination image as viewed by a user in an embodiment of the invention; and

FIG. 3 is a flow chart in block diagram indicating features of the invention.

Because the various layers and elements in the drawings have greatly different sizes, the drawings are not to scale.

### DETAILED DESCRIPTION OF THE INVENTION

A wide variety of see-through displays 10 are known in the art including head mounted displays, heads-up displays and helmet mounted displays. Typically see-through displays 10 include at least one image source including, a microdisplay and a light source, or a microprojector 8 with an internal light source, to provide digital information for display on the see-through display 10. Relay optics focus and transport the light of the image of the digital information to at least one substantially transparent see-through viewing area 12 where the digital information is displayed to a user. The user views a combination image including a see-through view of a portion of the external scene that is in front of the user, along with the overlaid image of the digital information.

See-through displays 10 can display combination images to one eye of the user or both eyes of the user. See-through displays 10 that display combination images to both eyes of the user can display the same combination image to both eyes or different combination images can be displayed to each eye as for example in a stereo image.

A variety of microdisplays are known in the art including, for example, organic light-emitting diode (OLED) displays, liquid crystal displays (LCDs), or liquid crystal on silicon (LCOS) displays. Microdisplays require an associated light source to provide an image of the digital information displayed on the microdisplay to the relay optics. Microdisplays can be transmissive, reflective or scanning. The associated light source can be LED, laser, fluorescent or incandescent.

Microprojectors 8 include an internal light source. Suitable microprojectors include: LCOS (liquid crystal on silicon), LCD, DLP (digital light projector) or laser scanning.

The relay optics can include refractive lenses, reflective lenses, diffractive lenses, holographic lenses or waveguides. The purpose of the relay optics is to focus the image of the digital information provided by the image source and also to direct the focused image of the digital image to a predetermined portion of the see-through viewing area 12 where the user views the combination image.

The see-through viewing area 12 is substantially transparent so that the user can view at least a portion of the external scene that is in front of the user. In the see-through display 10, the user simultaneously also views the image of the digital information provided by the image source. Wherein the image of the digital information is overlaid on at least a portion of the see-through viewing area 12 so the user views a combination image including the see-through view of the scene and the image of the digital information. Suitable see-through displays 10 are known in the art in which a digital image is presented for viewing by a user including: a device or surface including waveguides, holographic optical elements, polarized reflecting surfaces, partially reflecting surfaces, or switchable mirrors. The present invention concerns display devices that are useable as see-through displays 10 and that are useable to present digital information to a user without regard to the image content of the see-through viewing area 12. The invention provides a method for making the digital information more distinguishable when viewed against a see-through image of unknown image content.

In an embodiment of the invention, the digital information is modified prior to being displayed on the image source, such that the digital information has improved viewability in the combination image presented to the user on the see-through display 10. The digital information is modified to make the digital information more distinguishable from the see-through view that forms the background behind the digital information in the combination image that is viewed by the user. Various methods for making the digital information more distinguishable are included in the method of the invention, including: changing the color of the digital information, presenting the digital information on multiple regions of the see-through viewing area 12, presenting multiple copies of the digital information with contrasting characteristics and blinking the digital information. Since the invention provides methods for presenting digital information on a see-through display 10 without regard to the image content of the see through viewing area 12, the invention does not include methods or components to analyze the image content contained in the see-through view seen by the user. Instead, the invention includes methods to present the digital information in ways that make the digital information more distinguishable without knowledge of the image content contained in the see-through view. The invention can however be used in conjunction with display systems that do include methods and components to analyze the image content contained in the see-through view seen by the user, to further improve the viewability of the digital information.

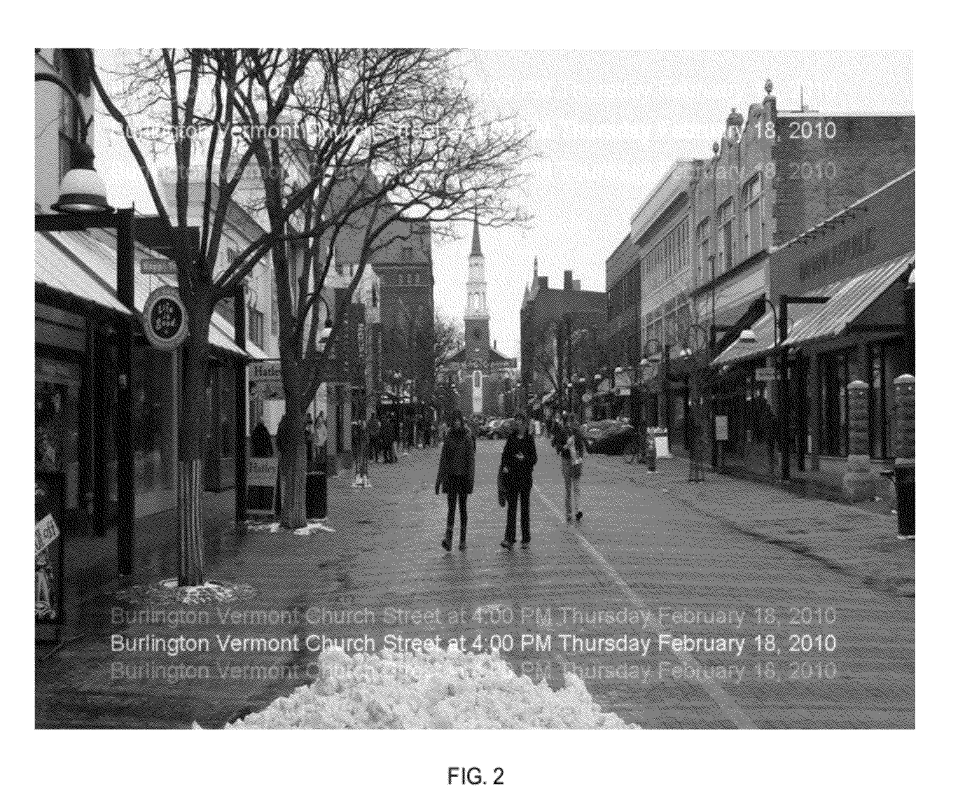

In a first embodiment of the invention, the modification of the digital information includes making multiple copies of the digital information wherein the multiple copies are different contrasting colors. The different colored multiple copies of the digital information are then displayed in different regions of the see-through viewing area. The different regions can be adjacent to each other to make it easier for the user to view the multiple copies of the digital information in aggregate. In this way, different portions of the multiple copies of the digital information will be viewed by the user against multiple different portions of the see-through view so that more contrast between the digital information and the see-through view is provided in aggregate to make the digital information more distinguishable. FIG. 2 provides an illustration of a combination image as would be seen by a user wherein the digital information is presented in multiple copies at the top and bottom of the see-through view. The digital information in FIG. 2 is shown as text where the top copy of the text was blue, the middle copy of the text was yellow and the bottom copy of the text was red in the original image that the illustration is based on. As can be seen in FIG. 2 some of the copies of the digital information are difficult to distinguish while other copies are easy to distinguish. The distinguishability of any portion of the digital information depends on the local contrast between the color of the digital information and the color of the see-through view in that portion of the combination image. As an example, the blue text in the top copy is very hard to distinguish in the top of the illustration where the sky is blue.

The multiple copies of the digital information can also be different in terms of relative brightness, style of presentation and size. Styles of presentation can include different types of text, edge outlines of text or images, high contrast images or different combinations of background and foreground.

In an alternate embodiment of the invention, the multiple copies of the digital information are displayed sequentially. As an example, different colored multiple copies of the digital information can be displayed sequentially in the same region of the see-through viewing area 12 so the user does not have to scan adjacent regions to distinguish the digital information. In this embodiment the user forms an aggregate image of the multiple copies of the digital information over time, as the multiple copies are displayed sequentially to the user.

In a further embodiment of the invention, the modification of the digital information includes forming a new copy of the digital information that blinks at a predetermined rate. The blinking copy of the digital information is then displayed in one or more regions of the see-through viewing area 12. Blinking is more distinguishable due to the enhanced sensitivity of the human eye to changes in the relative brightness of portions of a scene as when movement occurs in a scene.

In yet another embodiment of the invention, the modification of the digital image includes forming multiple copies of the digital information. The multiple copies are then displayed at multiple regions of the see-through viewing area 12 to provide more places where there is a distinguishable contrast between the digital information and the see-through view as seen by the user in the combination image. FIG. 2 shows an illustration of how having multiple copies of digital information presented in different regions of the combination image enable the digital information to be more distinguishable. The copy of the digital information presented at the bottom of the see-through view in FIG. 2 is overall easier to distinguish than the copy of the digital information presented at the top of the see-through view.

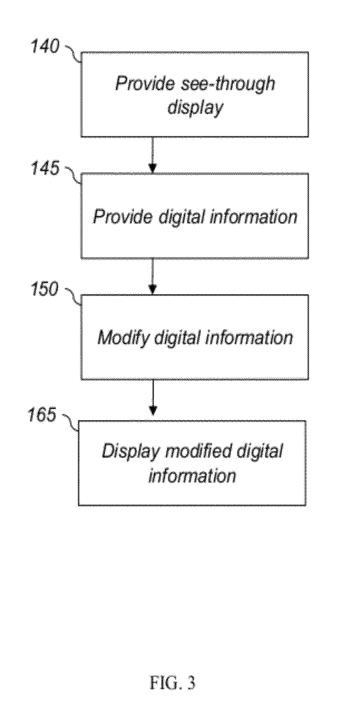

FIG. 3 is a flow chart of an embodiment of the invention. In step 140, a see-through display 10 is provided which is substantially transparent in a see-through viewing area 12 such that the user can view a portion of the external scene in front of the user. The see-through display 10 can also display an image of digital information on at least a portion of the see-through viewing area 12. In step 145, digital information is received by the control electronics of the see-through display 10. Wherein, the control electronics 9 can include a microprocessor, a digital signal processor or a computer along with elements to receive the digital information including digital storage and a wireless connection or a wire connection.

The digital information can be received by the control electronics 9 from an external source such as a computer, a cell phone, a wireless information source or an information source connected by a wire. The digital information can also be received from an information source that is internal to the see-through display 10. The digital information can be an image of a scene, an animation or data. Images can include: maps, directions, arrows indicating directions, pictures of people or objects, text, graphics such as a virtual keyboard or other interactive images such as are known in augmented reality. Data can include measurements of the environment (i.e. temperature, humidity or elevation), measurements relating to travel such as speed, location, direction or time and information acquired from an external source such as another computer, a cell phone or the internet.

In step 150, the digital information is modified by the control electronics 9 as was previously described to improve the viewability of the digital information in the combination image as viewed by the user on the see-through display 10. In step 165, the modified digital information is displayed on the image source of the see-through display 10 and as a result, the modified digital information is presented as an overlay to the see-through view seen by the user on the see-through viewing area 12 such that the digital information is more distinguishable by the user in the combination image.

The invention has been described in detail with particular reference to certain preferred embodiments thereof, but it will be understood that variations and modifications can be effected within the spirit and scope of the invention.

### PARTS LIST

8 microprojector or image source
9 control electronics
10 head-mounted display apparatus
12 see-through viewing area
14 ear pieces
140 step
145 step
150 step
165 step

1. A method for displaying information on a see-through display to provide improved viewability of digital information to a user, comprising:
(a) providing a see-through display including: control electronics, an image source with optics and a transparent viewing area, so that a user can view a scene with overlying digital information on the transparent viewing area of the see-through display;
(b) receiving digital information and providing the digital information to the control electronics;
(c) using the control electronics to modify the digital information to increase viewability; and
(d) providing the modified digital information to the image source so that the modified digital information is presented on the transparent viewing area overlying the viewed scene.

2. The method of claim 1, wherein the modified digital information includes multiple copies of the digital information.

3. The method of claim 2, wherein the multiple copies of the digital information are presented in adjacent regions of the transparent viewing area.

4. The method of claim 2 wherein at least two of the multiple copies of the digital information are contrasting colors.

5. The method of claim 4 wherein the multiple copies of the digital information are displayed in adjacent regions of the viewing area.

6. The method of claim 4 wherein the multiple copies of the digital information are displayed sequentially in time.

7. The method of claim 6 wherein the multiple copies of the digital information are displayed sequentially in the same region of the viewing area.

8. The method of claim 1 wherein the step of modifying includes forming a blinking version of the digital information.

9. The method of claim 8 wherein the blinking version of the digital information is displayed in more than one region of the viewing area.

10. The method of claim 1 wherein the step of modifying includes forming multiple copies of the digital information for display on multiple regions of the viewing area.

11. The method of claim 1 wherein the step of modifying includes forming multiple copies of the digital information with different styles of presentation.
